(19) United States
(12) Patent Application Publication
(10) Pub. No.: US 2025/0096963 A1
(43) Pub. Date: Mar. 20, 2025

(54) RANDOMIZING ASSIGNMENT OF STATIC CELLULAR STATIONS AND MOBILE CELLULAR STATIONS TO PROVIDE CELLULAR SERVICE TO A REGION

(71) Applicant: INTERNATIONAL BUSINESS MACHINES CORPORATION, Armonk, NY (US)

(72) Inventors: Sagar Tayal, Ambala City (IN); Saurabh Agrawal, Bangalore (IN); Utpal Mangla, Toronto (CA); Dinesh C. Verma, New Castle, NY (US); Mathews Thomas, Flower Mound, TX (US)

(21) Appl. No.: 18/469,265

(22) Filed: Sep. 18, 2023

(51) Int. Cl. H04L 5/00; H04W 16/26; H04W 72/542

(52) U.S. Cl. CPC H04L 5/0035; H04L 5/0005; H04W 16/26; H04W 72/542

(57) ABSTRACT

Provided are a computer program product, system, and method for managing radio-frequency spectrum in a network having a static cellular base station and a mobile cellular station servicing the radio-frequency spectrum. Information is maintained on physical resource blocks in the radio-frequency spectrum. Each physical resource block is defined for a frequency and timing advance from the static cellular base station. An assignment of the static cellular base station and the mobile cellular station are randomized, by timing advance and frequency, to provide cellular service to the physical resource blocks.

### BACKGROUND OF THE INVENTION

### 1. Field of the Invention

The present invention relates to a computer program product, system, and method for randomizing assignment of static cellular stations and mobile cellular stations to provide cellular service to a region.

### 2. Description of the Related Art

Cellular service providers maintain cellular towers, also referred to as base stations, to provide cellular service to a region within signal proximity to the base station.

The cellular service provider may also deploy unmanned autonomous vehicles (UAVs) having a cellular connection to the base station to provide cellular coverage to a region covered by the base station to supplement the base station coverage. The UAV provides uplink and downlink services to user equipment in a section of the region covered by the base station and communicates back to the base station to provide cellular service to user equipment. The UAVs may be allocated unused spectrum of the base station to provide coverage for the unused spectrum.

### SUMMARY

Provided are a computer program product, system, and method for managing radio-frequency spectrum in a network having a static cellular base station and a mobile cellular station servicing the radio-frequency spectrum. Information is maintained on physical resource blocks in the radio-frequency spectrum. Each physical resource block is defined for a frequency and timing advance from the static cellular base station. An assignment of the static cellular base station and the mobile cellular station are randomized, by timing advance and frequency, to provide cellular service to the physical resource blocks.

### BRIEF DESCRIPTION OF THE DRAWINGS

FIG. 1 illustrates an embodiment of a cellular network environment in which embodiments are implemented.

FIG. 2 illustrates an example of mobile cellular stations providing cellular service at timing advances from the base station.

FIG. 3 illustrates randomized time-frequency patterns to assign base station and mobile cellular stations to physical resource blocks in a region covered by the base station.

FIG. 4 illustrates a randomized assignment of sub-carrier signals to physical resource blocks in a region covered by the base station.

FIG. 5 illustrates an embodiment of operations to assign a base station and mobile cellular stations to provide cellular services to physical resource blocks in a region covered by the base station.

FIG. 6 illustrates a computing environment in which the components of FIG. 1 may be implemented.

### DETAILED DESCRIPTION

The description herein provides examples of embodiments of the invention, and variations and substitutions may be made in other embodiments. Several examples will now be provided to further clarify various embodiments of the present disclosure:

Example 1: A computer implemented method for managing radio-frequency spectrum in a network having a static cellular base station and a mobile cellular station servicing the radio-frequency spectrum. Information is maintained on physical resource blocks in the radio-frequency spectrum. Each physical resource block is defined for a frequency and timing advance from the static cellular base station. An assignment of the static cellular base station and the mobile cellular station are randomized, by timing advance and frequency, to provide cellular service to the physical resource blocks. Thus, embodiments advantageously randomize the assignment of base and mobile cellular stations to mitigate interference due to spectrum sharing.

Example 2: The limitations of any of Examples 1 and 3-10, where the method further comprises receiving information on signal quality from the static cellular base station and the mobile cellular station to different physical resource blocks. For each physical resource block of the physical resource blocks, a determination is made as to whether the static cellular base station and the mobile cellular station provide an acceptable signal quality to the physical resource block. The randomizing the assignment of the static cellular base station and the mobile cellular station occurs for each physical resource block for which both the static cellular base station and the mobile cellular station provide the acceptable signal quality. Thus, embodiments advantageously, in addition to mitigating interference by randomizing assignment of cellular stations to the spectrum, further ensure that only static or mobile cellular stations providing an acceptable signal quality are considered for the randomizing the assignment to a physical resource block.

Example 3: The limitations of any of Examples 1, 2 and 4-10, where the method further comprises that the randomizing the assignment of the static cellular base station and the mobile cellular station to the physical resource blocks comprises time frequency grid shifting to dynamically shift physical resource blocks at time-frequency grid positions to the mobile cellular station and the static cellular base station. Thus, embodiments advantageously shift the time-frequency grid positions of mobile cellular stations and terrestrial network cells to ensure a diverse allocation and randomization of resources and minimizes the possibility of interference.

Example 4: The limitations of any of Examples 1-3 and 5-10, where the method further comprises that the randomizing the assignment of the static cellular base station and the mobile cellular station to physical resource blocks comprises assigning sub-carrier spacings within the physical resource blocks to the static cellular base station and the mobile cellular station to have the static cellular base station and the mobile cellular station simultaneously provide cellular service within one physical resource block at different sub-carrier spacings. Thus, embodiments advantageously adjust the sub-carrier spacing to further enhance interference mitigation by varying the sub-carrier spacing to ensure that the peak-to-average power ratio (PAPR) of different resources is not identical, reducing the likelihood of interference.

Example 5: The limitations of any of Examples 1-4 and 6-10, where the method further comprises that the assigning sub-carrier spacings comprises randomizing an assignment of the sub-carrier spacings assigned to the static cellular base station and the mobile cellular station in a physical resource block, wherein the static cellular base station and the mobile cellular station are assigned different sub-carrier spacings in different physical resource blocks. Thus, embodiments advantageously use randomization to adjust the sub-carrier spacing to further enhance interference mitigation by varying the sub-carrier spacing to ensure that the peak-to-average power ratio (PAPR) of different resources is not identical, reducing the likelihood of interference.

Example 6: The limitations of any of Examples 1-5, and 7-10, where the method further comprises that there are a plurality of mobile cellular stations and static cellular base stations. The randomizing the assignment comprises randomizing the assignment of the static cellular base stations and the mobile cellular stations to the physical resource blocks. Thus, embodiments advantageously mitigate interference among a plurality of mobile and static cellular base stations by randomizing how the mobile and static base stations are assigned to physical resource blocks.

Example 7: The limitations of any of Examples 1-6 and 8-10, where the method further comprises that the mobile cellular station comprises a plurality of cellular connected unmanned aerial vehicle (UAV). Information is received on location, speed, height and direction of the cellular connected UAVs to determine cell coverage of the cellular connected UAVs with respect to the physical resource blocks. A determination is made of expected locations of the cellular connected UAVs. A determination is made of signal quality the static cellular base station and the cellular connected UAVs, at the expected locations, provide for the physical resource blocks at a timing advance. A determination is made of the cellular connected UAVs and the static cellular base station that provide acceptable signal quality to the physical resource blocks. The cellular connected UAVs and the static cellular base station are randomly assigned to physical resource blocks to which the cellular connected UAVs and the static cellular base station provide acceptable signal quality to provide cellular service to the physical resource blocks. Thus, embodiments advantageously mitigate interference provide improved spectrum management and interference mitigation to ensure the coexistence of UAVs and terrestrial networks while maintaining satisfactory service quality.

Example 8: The limitations of any of Examples 1-7, 9, and 10, where the method further comprises maintaining randomized time-frequency patterns of assignment of physical resource blocks to the static cellular base station and the mobile cellular station. The static cellular base station and the mobile cellular station are assigned to physical resource blocks based on the randomized time-frequency patterns. Thus, embodiments advantageously ensures that neighboring UAVs and terrestrial network cells operate on different patterns, reducing the likelihood of interference.

Example 9 is a machine-readable storage including machine-readable instructions, when executed, to implement a method or realize an apparatus as claimed in any preceding Example.

Example 10 is an apparatus comprising means to perform a method as claimed in any preceding example.

Additionally, or alternatively, an embodiment in which the element of Example 1 randomizing the assignment of the static and mobile cellular base stations further comprises providing a repository of randomized time-frequency assignment patterns of the cellular base and mobile stations to physical resource blocks at different time-frequency coordinates and to sub-carrier signals within the physical resource blocks. This alternative embodiment using randomized time-frequency assignment patterns to assign mobile and static cellular stations to different timing advance-frequency resource blocks and sub-carrier spacings ensures that neighboring mobile stations and terrestrial base stations operate on different patterns, reducing the likelihood of interference.

The increased use of UAVs to provide cellular service has lead to significant spectrum collision issues, especially in spectrum-demanding environments such as urban areas. The dynamic and mobile characteristics of UAVs increases the complexity to optimize spectrum usage and interference management between UAVs and terrestrial networks, including the base station and user equipment. Further, UAVs operating at higher altitudes than terrestrial networks exacerbate interference, affecting a larger number of terrestrial network users. This overlapping spectrum of the UAVs results in increased interference and poor service quality for end-users. This problem intensifies as the number of UAVs continue to increase along with the use of heterogeneous communication technologies. Described embodiments provide improved spectrum management and interference mitigation to ensure the coexistence of UAVs and terrestrial networks while maintaining satisfactory service quality.

Described embodiments provide improved technology for managing the spectrum with a centralized entity to manage the assignment of multiple base stations and mobile stations, such as UAVs, to physical resource blocks in a region. With described embodiments, the same spectrum blocks may be concurrently utilized when needed due to spectrum scarcity. Described embodiments manage interference due to spectrum sharing by using randomized patterns for resource allocation at physical resource blocks considering timing advance and sub-carrier spacing tuning to randomize peak-to-average-power-ratio (PAPR).

UAVs' dynamic movements create overlapping coverage with terrestrial networks, which constantly changes. Described embodiments address this issue by gathering information on UAV location and parameters for effective spectrum management. The centralized manager assesses overlapping UAV coverage area, connected users, and required services based on cellular network coverage timing advance. Described embodiments utilize randomized time-frequency patterns to assign the base station and UAVs to physical resource blocks to significantly minimize co-channel interference between UAVs and terrestrial networks. Further embodiments utilize a repository of diverse time-frequency patterns that are randomly assigned to UAVs and terrestrial networks. This randomization ensures that neighboring UAVs and terrestrial network cells operate on different patterns, reducing the likelihood of interference. Described embodiments utilize randomization techniques including time-frequency grid shifting to shift the time-frequency grid positions of UAVs and terrestrial network cells. This ensures a diverse allocation and randomization of resources and minimizes the possibility of interference.

Described embodiments further provide for sub-carrier spacing (SCS) adjustment for physical resource blocks having sub-carrier spacing. The described embodiments adjust the sub-carrier spacing to further enhance interference mitigation by varying the sub-carrier spacing to ensure that the peak-to-average power ratio (PAPR) of different resources is not identical, reducing the likelihood of interference.

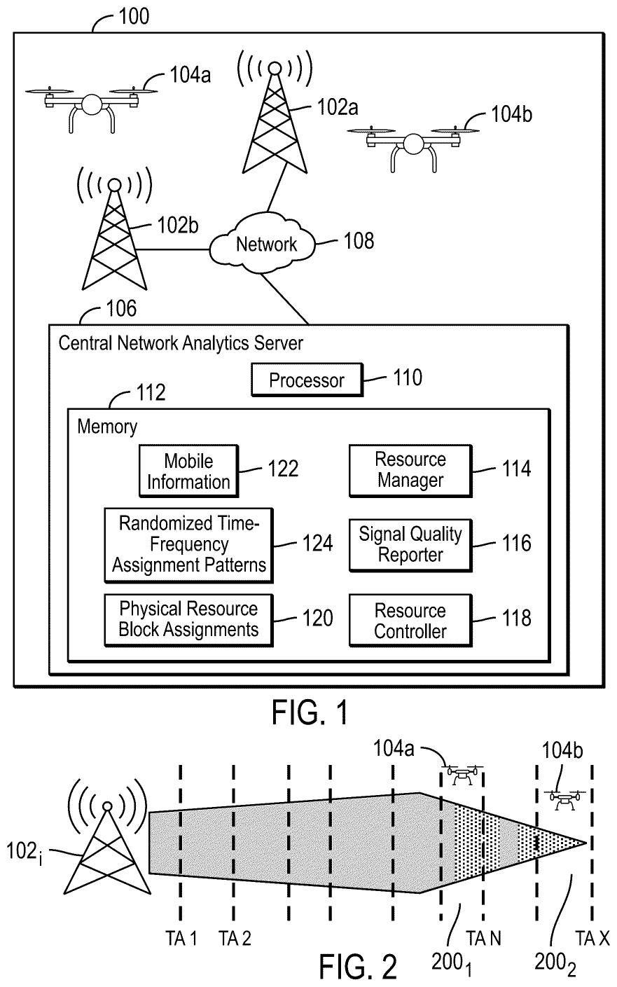

FIG. 1 illustrates an embodiment of a cellular network 100 in which embodiments are implemented, such as, but not limited to, a 4G, 5G or 6G network. The cellular network 100 includes a plurality of base stations 102a, 102b, also referred to as static cellular stations or terrestrial stations, and a plurality of cellular connected mobile stations 104a, 104b, such as unmanned aerial vehicles (UAVs), satellites, etc. There may be fewer or more of the base stations 102a, 102b and cellular connected mobile stations 104a, 104b. The cellular connected mobile stations 104a, 140b may reuse the cellular base stations 102a, 102b spectrum to provide connectivity to user equipment in the cellular area and to other UAVs to improve signal quality in the regions serviced by the cellular base stations 102a, 102b. The cellular connected mobile stations 104a, 104b may detect terrestrial signals from user equipment over a much larger region than the connected base stations 102a, 102b because the mobile stations 104a, 104b may have more line-of-sight channels with the terrestrial base stations 102a, 102b and user equipment. This allows the mobile stations 104a, 104b to assist the base stations 102a, 102b in providing cellular service while mitigating intercell interference.

A central network analytics server 106 is in communication with the base stations 102a, 102b over a network 108 and schedules assignment of the stations 102a, 102b, 104a, 104b to provide cellular service to physical resource blocks defining the smallest unit of services that can be allocated to user equipment by the base stations 102a, 102b. Sub-carrier signals may be assigned to the resource blocks to expand the channels available in the physical resource blocks. A resource block may have a frequency width, e.g., 180 kHz, and one slot long in time. The server 106 communicates with cellular connected mobile stations 104a, 104b through the base stations 102a, 102b.

The central network analytics server 106 includes a processor 110 and a main memory 112 including a resource manager 114, signal quality reporter 116, and resource controller 118 to manage assignment of the base stations 102a, 102b and mobile stations 104a, 104b to physical resource blocks representing time-frequency slots. The resource manager 114 may record the assignment of stations 102a. 102b, 104a, 104b to physical resource blocks and to sub-carrier signals within physical resource blocks in the physical resource block assignments 120. The resource manager 114 may gather mobile information 122 on the mobile stations 104a, 104b, such as current location, speed, altitude, direction travelling, etc. The signal quality reporter 116 may receive signal quality information from the base stations 102a, 102b and mobile stations 104a, 104b on the signal quality at different timing advances from the base stations 102a, 102b. The resource manager 114 may use randomized time-frequency assignment patterns 124 of the stations 102a, 102b, 104a, 104b to physical resource blocks at different time-frequency coordinates and to sub-carrier signals within the physical resource blocks.

Randomizing the assignment of stations 102a, 102b, 104a, 104b to the physical resource blocks minimizes likelihood of interference. In this way, the resource manager 114 employs a repository of diverse time-frequency patterns 124 that are randomly assigned to UAVs and terrestrial networks. This randomization ensures that neighboring UAVs and terrestrial network cells operate on different patterns, reducing the likelihood of interference.

The resource controller communicates to the base stations 102a, 102b over the network 108 the assignment of stations 102a, 102b, 104a, 104b to physical resource blocks. The base stations 102a, 102b would communicate the assignments to the mobile cellular stations 104a. 104b to control the mobile cellular stations 104a, 104b to provide uplink and downlink cellular service to the physical resource blocks to which they are assigned.

The memory 112 may comprise suitable volatile or non-volatile memory devices known in the art. For instance, the memory 112 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 114, 116, 118 may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 114, 116, 118, among others, may be accessed by the processor 110 from the memory 112 to execute. Alternatively, some or all of the program components 114, 116, 118 may be implemented in separate hardware devices, such as Application Specific Integrated Circuit (ASIC), Field Programmable Gate Arrays (FPGAs) and other hardware devices.

The functions described as performed by the program components 114, 116, 118, among others, may be implemented as program code in fewer program modules than shown or implemented as program code throughout a greater number of program modules than shown.

The network 108 may comprise a network such as a Storage Area Network (SAN), Local Area Network (LAN), Intranet, the Internet, Wide Area Network (WAN), peer-to-peer network, wireless network, arbitrated loop network, etc.

FIG. 2 provides an illustration of timing advance units (TAs) from a base station 102; and how mobile stations 104a, 104b are located within timing advance units 200₁, 200₂ from the base station 102ᵢ. A timing advance (TA) value corresponds to the length of time a signal takes to reach the base station from user equipment. In this example, because the mobile stations 104a, 104b are more proximate to certain timing advance regions they may have better line of sight to user equipment in these timing advance regions 200₁ and 200₂ and thus provide a higher signal quality for uplink and downlink to the user equipment in the regions 200₁, 200₂.

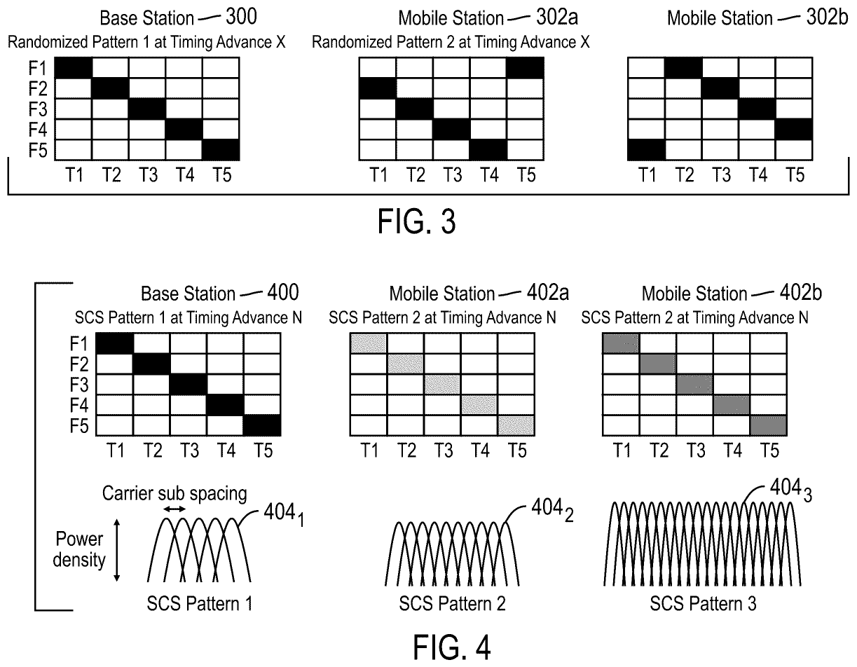

FIG. 3 provides an example of the randomized time frequency assignment patterns 300, 302a, 302b for a base station 102a and mobile stations 104a, 104b, respectively. The boxes in the grids represent physical resource blocks at different frequencies (Fᵢ) and timing advances (Tⱼ). This randomization pattern for assigning the base station 102a and mobile stations 104a, 104b reduces interference in servicing user equipment in the physical resource blocks.

FIG. 4 provides an example of randomized sub-carrier signal assignment patterns 124 for the base stations 400 and mobile stations 402a, 402b. The boxes in the grids represent physical resource blocks at different frequencies (Fᵢ) and time advances (Tⱼ), and the different shaded grid boxes represent different sub-carrier signal patterns 404₁, 404₂, 404₃ within the randomized pattern of physical resource blocks. This randomization pattern for assigning the sub-carrier signals to base station 102a and mobile stations 104a, 104b within physical resource blocks ensures that the peak-to-average-power-ratio (PAPR) of different resources is not identical, reducing the likelihood of interference.

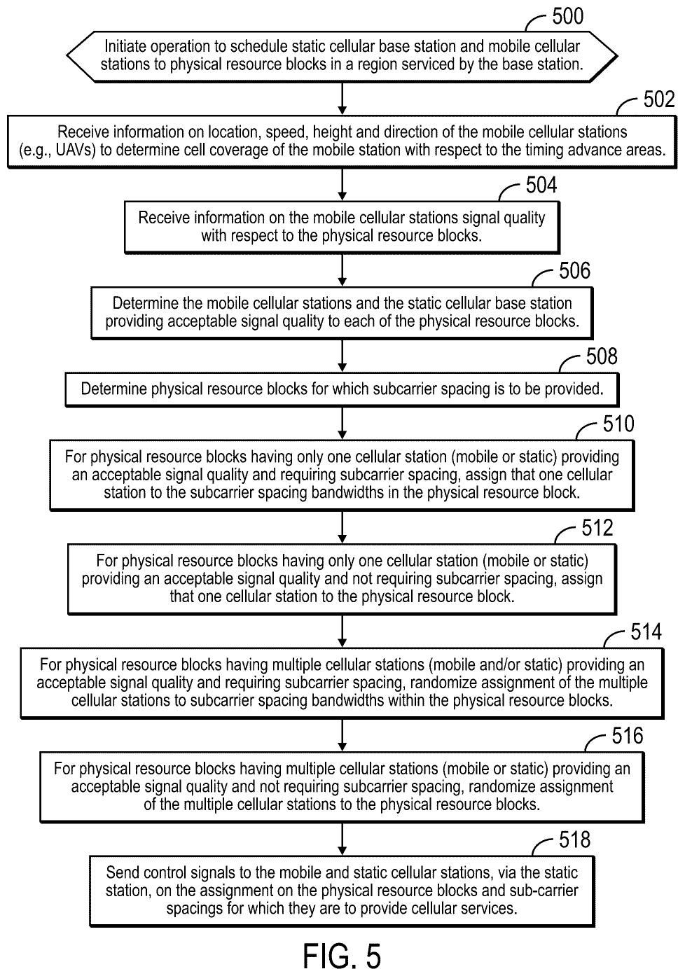

FIG. 5 illustrates an embodiment of operations performed by the resource manager 114, signal quality reporter 116, and resource controller 118 to assign a base station 102a and mobile stations 104a, 104b to physical resource blocks to minimize interference among the mobile stations 104a, 104b and the base station 102a. The operations of FIG. 5 are described with respect to one base station 102a, but may be applied to all the relevant base stations 102b and the timing advance areas, i.e., physical resource blocks, managed by the base station 102a. Upon initiating (at block 500) an operation to schedule a static cellular base station 102a and mobile cellular stations 104a, 104b to physical resource blocks, the resource manager 114 receives (at block 502) mobile information 122 on location, speed, height and direction of the mobile cellular stations 104a, 104b (e.g., UAVs) to determine cell coverage of the cellular connected UAVs with respect to the timing advance areas, i.e., physical resource blocks. The signal quality reporter 116 receives (at block 504) information on the signal quality the mobile cellular stations 104a, 104b and the base station 102a provide with respect to the timing advances or physical resource blocks. The resource manager 114 determines (at block 506) the mobile cellular stations 104a, 104b and the static cellular base station 102a providing acceptable signal quality to each of the physical resource blocks, or timing advances from the base station 102a. The resource manager 114 determines (at block 508) physical resource blocks for which sub-carrier spacing is to be provided.

The resource manager 114 then performs the operations at blocks 510 through 516 to randomize assignment of the static 102a and mobile 104a, 104b base stations to physical resource blocks to minimize interference between resource blocks. For physical resource blocks having only one cellular station (mobile 104a, 104b or static 102a) providing an acceptable signal quality and requiring sub-carrier spacing, the resource manager 114 assigns (at block 510) that one cellular station 104a, 104b or 102, providing the acceptable signal quality, to the sub-carrier spacing bandwidths in the physical resource block. For physical resource blocks having only one cellular station (mobile or static) providing an acceptable signal quality and not requiring sub-carrier spacing, the resource manager 114 assigns (at block 512) that one cellular station to the physical resource block. For physical resource blocks having multiple cellular stations (mobile and/or static) providing an acceptable signal quality and requiring sub-carrier spacing, the resource manager 114 randomizes (at block 514) the assignment of the multiple cellular stations to sub-carrier spacing bandwidths within the physical resource blocks. The resource manager 114 may use the randomized time-frequency assignment patterns 124, such as the assignment patterns for sub-carrier signals shown in FIG. 4, to assign the stations 102a, 104a, 104b to the sub-carrier signals within physical resource bocks.

For physical resource blocks having multiple cellular stations (mobile or static) providing an acceptable signal quality and not requiring sub-carrier spacing, the resource manager 114 randomizes (at block 516) the assignment of the multiple cellular stations 102a, 104a, 104b to the physical resource blocks. The resource manager 114 may use the randomized time-frequency assignment patterns 124, such as the assignment patterns for timing advance-frequency shown in FIG. 3, to assign the stations 102a, 104a, 104b to the physical resource bocks. After determining the assignment of stations 102a, 104a, 104b to physical resource blocks at blocks 510-516, the assignments may be recorded in the physical resource block assignments 120. The resource controller 118 sends (at block 518) control signals to the mobile and static cellular stations, via the static cellular station 102a, on the physical resource block and sub-carrier spacings for which they are to provide cellular services, uplink and downlink. The cellular stations 102a, 104a, 104b use the information from the resource controller 118 to provide cellular service to the physical resource blocks to which they are assigned.

The randomization operations of FIG. 5 to assign stations 102a, 104a, 104b to different timing advance-frequency resource blocks and sub-carrier spacings ensures that neighboring mobile stations and terrestrial base stations operate on different patterns, reducing the likelihood of interference.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

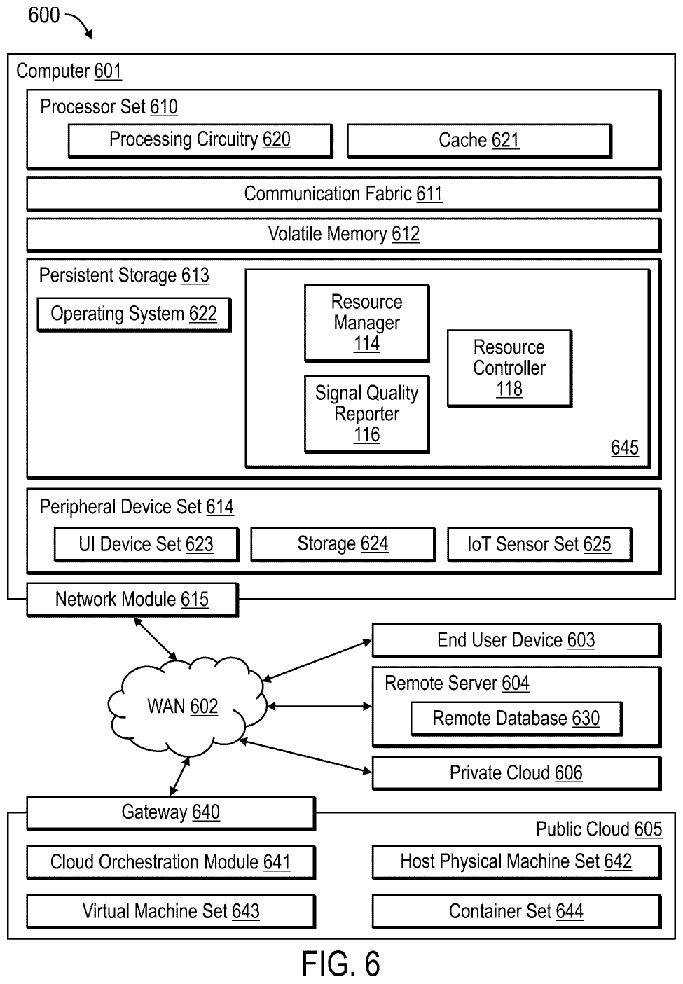

With respect to FIG. 6, computing environment 600 contains an example of an environment for the execution of at least some of the computer code involved in performing the inventive methods, including the resource manager 114, signal quality reporter, 116 to assign static and mobile stations to physical resource blocks, at block 645. In addition to block 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 645, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The letter designators, such as i and j, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for managing radio-frequency spectrum in a network having a static cellular base station and a mobile cellular station servicing the radio-frequency spectrum, the computer program product comprises a computer readable storage medium having program instructions embodied therewith that when executed cause operations, the operations comprising:
maintaining information on physical resource blocks in the radio-frequency spectrum, where each physical resource block is defined for a frequency and timing advance from the static cellular base station; and
randomizing, by timing advance and frequency, an assignment of the static cellular base station and the mobile cellular station to provide cellular service to the physical resource blocks.

2. The computer program product of claim 1, wherein the operations further comprise:
receiving information on signal quality from the static cellular base station and the mobile cellular station to different physical resource blocks; and
for each physical resource block of the physical resource blocks, determining whether the static cellular base station and the mobile cellular station provide an acceptable signal quality to the physical resource block, wherein the randomizing the assignment of the static cellular base station and the mobile cellular station occurs for each physical resource block for which both the static cellular base station and the mobile cellular station provide the acceptable signal quality.

3. The computer program product of claim 1, wherein the randomizing the assignment of the static cellular base station and the mobile cellular station to the physical resource blocks comprises time frequency grid shifting to dynamically shift physical resource blocks at time-frequency grid positions to the mobile cellular station and the static cellular base station.

4. The computer program product of claim 1, wherein the randomizing the assignment of the static cellular base station and the mobile cellular station to physical resource blocks comprises assigning sub-carrier spacings within the physical resource blocks to the static cellular base station and the mobile cellular station to have the static cellular base station and the mobile cellular station simultaneously provide cellular service within one physical resource block at different sub-carrier spacings.

5. The computer program product of claim 4, wherein the assigning sub-carrier spacings comprises randomizing an assignment of the sub-carrier spacings assigned to the static cellular base station and the mobile cellular station in a physical resource block, wherein the static cellular base station and the mobile cellular station are assigned different sub-carrier spacings in different physical resource blocks.

6. The computer program product of claim 1, wherein there are a plurality of mobile cellular stations and static cellular base stations, wherein the randomizing the assignment comprises randomizing the assignment of the static cellular base stations and the mobile cellular stations to the physical resource blocks.

7. The computer program product of claim 1, wherein the mobile cellular station comprises a plurality of cellular connected unmanned aerial vehicle (UAV), wherein the operations further comprise:
receiving information on location, speed, height and direction of the cellular connected UAVs to determine cell coverage of the cellular connected UAVs with respect to the physical resource blocks;
determining expected locations of the cellular connected UAVs;
determining signal quality the static cellular base station and the cellular connected UAVs, at the expected locations, provide for the physical resource blocks at a timing advance;
determining the cellular connected UAVs and the static cellular base station that provide acceptable signal quality to the physical resource blocks; and
randomly assigning the cellular connected UAVs and the static cellular base station to physical resource blocks to which the cellular connected UAVs and the static cellular base station provide acceptable signal quality to provide cellular service to the physical resource blocks.

8. The computer program product of claim 1, wherein the operations further comprise:
maintaining randomized time-frequency patterns of assignment of physical resource blocks to the static cellular base station and the mobile cellular station, wherein the static cellular base station and the mobile cellular station are assigned to physical resource blocks based on the randomized time-frequency patterns.

9. A system for managing radio-frequency spectrum in a network having a static cellular base station and a mobile cellular station servicing the radio-frequency spectrum, comprising:
a processor; and
a computer readable storage medium having program instructions embodied therewith that when executed cause operations, the operations comprising:
maintaining information on physical resource blocks in the radio-frequency spectrum, where each physical resource block is defined for a frequency and timing advance from the static cellular base station; and
randomizing, by timing advance and frequency, an assignment of the static cellular base station and the mobile cellular station to provide cellular service to the physical resource blocks.

10. The system of claim 9, wherein the operations further comprise:
receiving information on signal quality from the static cellular base station and the mobile cellular station to different physical resource blocks; and
for each physical resource block of the physical resource blocks, determining whether the static cellular base station and the mobile cellular station provide an acceptable signal quality to the physical resource block, wherein the randomizing the assignment of the static cellular base station and the mobile cellular station occurs for each physical resource block for which both the static cellular base station and the mobile cellular station provide the acceptable signal quality.

11. The system of claim 9, wherein the randomizing the assignment of the static cellular base station and the mobile cellular station to the physical resource blocks comprises time frequency grid shifting to dynamically shift physical resource blocks at time-frequency grid positions to the mobile cellular station and the static cellular base station.

12. The system of claim 9, wherein the randomizing the assignment of the static cellular base station and the mobile cellular station to physical resource blocks comprises assigning sub-carrier spacings within the physical resource blocks to the static cellular base station and the mobile cellular station to have the static cellular base station and the mobile cellular station simultaneously provide cellular service within one physical resource block at different sub-carrier spacings.

13. The system of claim 9, wherein the mobile cellular station comprises a plurality of cellular connected unmanned aerial vehicle (UAV), wherein the operations further comprise:
receiving information on location, speed, height and direction of the cellular connected UAVs to determine cell coverage of the cellular connected UAVs with respect to the physical resource blocks;
determining expected locations of the cellular connected UAVs;
determining signal quality the static cellular base station and the cellular connected UAVs, at the expected locations, provide for the physical resource blocks at a timing advance;
determining the cellular connected UAVs and the static cellular base station that provide acceptable signal quality to the physical resource blocks; and
randomly assigning the cellular connected UAVs and the static cellular base station to physical resource blocks to which the cellular connected UAVs and the static cellular base station provide acceptable signal quality to provide cellular service to the physical resource blocks.

14. The system of claim 9, wherein the operations further comprise:
maintaining randomized time-frequency patterns of assignment of physical resource blocks to the static cellular base station and the mobile cellular station, wherein the static cellular base station and the mobile cellular station are assigned to physical resource blocks based on the randomized time-frequency patterns.

15. A method for managing radio-frequency spectrum in a network having a static cellular base station and a mobile cellular station servicing the radio-frequency spectrum, comprising:
maintaining information on physical resource blocks in the radio-frequency spectrum, where each physical resource block is defined for a frequency and timing advance from the static cellular base station; and
randomizing, by timing advance and frequency, an assignment of the static cellular base station and the mobile cellular station to provide cellular service to the physical resource blocks.

16. The method of claim 15, comprising:
receiving information on signal quality from the static cellular base station and the mobile cellular station to different physical resource blocks; and
for each physical resource block of the physical resource blocks, determining whether the static cellular base station and the mobile cellular station provide an acceptable signal quality to the physical resource block, wherein the randomizing the assignment of the static cellular base station and the mobile cellular station occurs for each physical resource block for which both the static cellular base station and the mobile cellular station provide the acceptable signal quality.

17. The method of claim 15, wherein the randomizing the assignment of the static cellular base station and the mobile cellular station to the physical resource blocks comprises time frequency grid shifting to dynamically shift physical resource blocks at time-frequency grid positions to the mobile cellular station and the static cellular base station.

18. The method of claim 15, wherein the randomizing the assignment of the static cellular base station and the mobile cellular station to physical resource blocks comprises assigning sub-carrier spacings within the physical resource blocks to the static cellular base station and the mobile cellular station to have the static cellular base station and the mobile cellular station simultaneously provide cellular service within one physical resource block at different sub-carrier spacings.

19. The method of claim 15, wherein the mobile cellular station comprises a plurality of cellular connected unmanned aerial vehicle (UAV), further comprising:
receiving information on location, speed, height and direction of the cellular connected UAVs to determine cell coverage of the cellular connected UAVs with respect to the physical resource blocks;
determining expected locations of the cellular connected UAVs;
determining signal quality the static cellular base station and the cellular connected UAVs, at the expected locations, provide for the physical resource blocks at a timing advance;
determining the cellular connected UAVs and the static cellular base station that provide acceptable signal quality to the physical resource blocks; and
randomly assigning the cellular connected UAVs and the static cellular base station to physical resource blocks to which the cellular connected UAVs and the static cellular base station provide acceptable signal quality to provide cellular service to the physical resource blocks.

20. The method of claim 15, further comprising:
maintaining randomized time-frequency patterns of assignment of physical resource blocks to the static cellular base station and the mobile cellular station, wherein the static cellular base station and the mobile cellular station are assigned to physical resource blocks based on the randomized time-frequency patterns.
